(19) United States
(12) Patent Application Publication
(10) Pub. No.: US 2002/0095362 A1
(43) Pub. Date: Jul. 18, 2002

(54) Financial methods and systems

(76) Inventors: Brij Masand, (US); Vishwamitra RamaKrishnan, (US)

Correspondence Address: LUCASH, GESMER & UPDEGROVE, LLP, 40 BROAD ST, SUITE 300, BOSTON, MA, 02109, US

(21) Appl. No.: 09/843,057

(22) Filed: Apr. 26, 2001

Related U.S. Application Data
(60) Provisional application No. 60/200,213, filed on Apr. 28, 2000.
(60) Provisional application No. 60/200,318, filed on Apr. 28, 2000.
(60) Provisional application No. 60/200,651, filed on Apr. 28, 2000.
(60) Provisional application No. 60/200,652, filed on Apr. 28, 2000.

(51) Int. Cl. G06F 17/60

(52) U.S. Cl. 705/35

(57) ABSTRACT

Computer-implemented methods and systems support financial decisions by searching for securities or portfolios similar to one or more reference securities or portfolios; alerting a user when the number of references to a selected financial instrument on at least one selected Web site exceeds a predetermined amount; and/or enabling a user to graphically display financial entities and dynamic relationships between them.

### CITATION OF PROVISIONAL APPLICATIONS

This application for U.S. patent is based upon and claims the priority of U.S. Provisional Applications for Patent Serial Nos. 60/200,213; 60/200,318; 60/200,651; and 60/200,652, all filed Apr. 28, 2000 and incorporated in their entirety herein by reference.

### FIELD OF THE INVENTION

The present invention relates generally to financial systems and methods, and, more particularly, to computer-implemented systems and methods for collecting, correlating and displaying information about selected securities and other financial entities.

### BACKGROUND OF THE INVENTION

The use of personal computers (PCs), personal digital assistants (PDAs) and the Internet, for researching and monitoring stocks, bonds, mutual funds and other securities has grown enormously in recent years. Examples are disclosed in the following U.S. Pat. Nos.:

6,161,098

5,220,500

5,999,918

6,041,326

5,778,357

5,414,838

5,987,432

6,049,783

5,689,651

5,710,889

5,893,079

In addition, a number of Web sites such as bigcharts.com, tradeworx.com, wealthhound.com, and mobile-wms.com provide financial information and tools to users via the Internet.

Holders of securities frequently wish to track relationships between the securities, monitor Internet message-board and other sources that may reflect unusual trading or other activity in a security, search for securities similar to a given security, or otherwise carry out similar information-collection, correlation and display tasks.

Conventional financial data collection, correlation and display systems, however, are often cumbersome and inflexible. For example, if a user wishes to locate Internet messages concerning a particular security, he or she would need to manually connect to an Internet message board and extract the desired messages, expending considerable time and energy in the process.

A user may also wish to search for similar stocks in the financial planning process. Conventional methods for locating securities involve techniques such as stock screening where explicit criteria need to be specified in the form of numerous financial attributes (such as PE ratio between 20 and 100, market cap between 2 and 5 billion etc.). Such a ‘hard’ search criteria can easily miss securities that match the specified security in most attributes but have some outlying values in a minority of attributes.

In addition, a user involved in financial planning may wish to track relationships between securities or other financial entities. The existing method for representing relationships between stocks or market indices consists of “watch lists”, essentially lists of stock tickers (or other symbols) with price changes shown right next to the ticker. Watch lists, being linear in nature, offer no way to represent relationships between the stocks, they merely act as a means for grouping stocks together. The user has to bear the cognitive burden of deriving implications for related stocks when a specific stock shows a significant price change. The user has to remember what the various relationships are and use that information to derive the implications for other stocks of changes in one stock. This process, apart from being wasteful in that the same information is dredged up from memory every time an event happens, is also time-consuming. Thus the user loses valuable time, and potentially financial opportunity, while he or she processes the information.

Thus, there exists a need for systems that would permit a user to be alerted of unusual activity connected with a given security, such as when the number of message-board postings regarding a particular security exceed a predetermined number.

There also exists a need for systems that would permit a user to define relationships between stocks or other securities, and track changes therebetween.

In addition, there exists a need for systems that would permit users to search for securities based on “soft” matching, using similarity dimensions such as price, market capitalization, valuation, balance sheet strength, operating history, price performance, profitability, size, and the like.

### SUMMARY OF THE INVENTION

The present invention includes systems and methods that enable users to search for similar securities, manage financial instrument portfolios, scan and collect Internet messages and stories regarding specified securities, and identify and display relationships between securities or other financial entities.

One aspect of the present invention includes a web-based methods and systems that enable the user to collect, correlate and synthesize critical information across multiple financial holdings. This aspect of the invention collects, filters and distills information from institutional and web-based information sources and reformats the data for desktop and/or mobile device viewing.

Another aspect of the present invention includes computer-implemented methods and systems for supporting financial decisions. The system alerts a user when the number of references to a stock or other security, on at least one Internet site, exceeds a predetermined number. The system searches selected Internet sites for references to the security and counts occurrences. The system sends an alert to the user if the number of references exceeds a threshold number, which may be an average of the number of references per day. The threshold number could also be the average number of references in the past five days.

In another aspect, the invention includes methods and systems that permit users to search for similar securities by defining similarity criteria, each with an associated relative weight. The user can specify similarity criteria such as market valuation, balance sheet strength, operating history, price performance, growth, profitability, dividend potential, market capitalization, or entity size. The user can also define a search metric to measure the similarity distance between the user-specified security and each of the similar securities being searched. In one embodiment, the metric is a weighted Euclidean distance. In the preferred embodiment, the system calculates similar stocks by calculating the square of the distance for each attribute compared between the two stocks. The system then sorts the similar securities using a user-defined priority list for display to the user. The user can also search for dissimilar stocks within a defined set of stocks.

In a further aspect, the invention enables users to define and investigate relationships between securities or other financial entities, in order to track changes therebetween. In one embodiment, securities are represented by color-coded icons. The size of the icon represents a parameter of the financial entity, such as market capitalization, revenues or earnings of the financial entity. The user can specify how to modify the icon to show changes in the financial value of the stock. For example, the daily price change of a stock could be reflected by the color of the icon. A line between two icons represents a user-defined dynamic relationship between the two financial entities. The line is also color-coded, and the width of the line is defined as a function of the relative relationship between the connected entities. The user can thus make financial decisions by observing the relationship between various changes in stock prices, and can track changes through various entities or markets.

### BRIEF DESCRIPTION OF THE DRAWINGS

The foregoing aspects and other features of the present invention are explained in the following description, taken in connection with the accompanying drawings, wherein:

FIG. 1 is a method flow chart of one embodiment of the invention showing steps of selecting, scanning, and listing messages associated with a financial instrument.

FIG. 2 is an example of a screen shot generated by a PDA or other processor, in accord with the invention, showing a Watch List of securities.

FIG. 3 is a method flow chart of another embodiment of the invention.

FIG. 4 is shows a sample table of messages returned by a message board scan and return.

FIG. 5 is an entity diagram of one embodiment of the invention.

FIG. 6 is a flow chart depicting a method of selecting securities similar to a user-defined security.

FIG. 7 is depicts an example of a table of variables from which the user may select to define similarity views in accordance with the invention; and

FIG. 8 shows an example of a stock similarity search result.

### DETAILED DESCRIPTION OF THE INVENTION

The present invention includes methods and systems that enable users to: (1) manage financial instrument portfolios; (2) scan and alert regarding messages and other information items concerning specified securities; (3) identify and display relationships between securities or other financial entities; and (4) search for similar securities. Each of these aspects will next be described.

(1) Portfolio Manager:

This aspect of the invention enables the user, who may be an investment professional, or other person interested in tracking financial investments, to synthesize critical information across multiple financial holdings and solve the problem of information overload.

The system of the present invention collects, filters and distills information from institutional and web-based information sources and reformats the data for desktop and/or mobile device viewing. The user customizes the application with the user's security data and personal settings. The user uploads holdings to a central server having multiple financial feeds where the holdings are analyzed in real time according to the user's predefined criteria.

The user may also link portfolios to national indexes for tracking trends, create a Watch List of selected stocks, and create Alerts to be sent to the user when predetermined critical price movements or news events occur. The user can also create a Watch List that is available when the user is logged on to a central server. The Watch List allows the user to monitor particular stocks. The user may also select a news option about a specific stock or financial instrument. The central server will then execute a search on the Internet and/or on specific news sources for news relevant to the specific financial instrument. Similarly, the user may select a chart option whereby the central server will chart or provide a chart of a specific financial instrument's recent activity.

The central server provides at least five analysis views of the user's portfolios, as described below:

1) The Gain/Loss view allows the user to see holdings from two perspectives, the performance of the user's portfolios in the aggregate and a detailed view of the performance of the user's individual portfolios.

2) The Aggregate Report shows nominal and percent changes in market value with comparisons to benchmarks. Information is displayed under the following column labels: End of Day (EOD) Market Value, EOD Change, EOD Percent Change, Benchmark, EOD Benchmark Percent Change, End of Market (EOM) Change, EOM Portfolio Percent Change, EOM Benchmark Percent Change, and Benchmark/Port EOM Difference. The Benchmark data reflects the Index associated with the portfolio.

3) The Detailed Report, used when a particular portfolio is selected, shows changes in the securities that make up the portfolio selected. Information is displayed under the following column labels: Price, Change, Percent Change, Quantity Held, Market Value and Percent of Total.

4) The Cash Holdings view shows the distribution of market value across asset classes. The Industry Exposure view shows distribution of market value across industries.

5) The Price/Earnings (P/E) exposure view shows distribution based on P/E in 8 increments. The Holdings view shows a detailed list of positions.

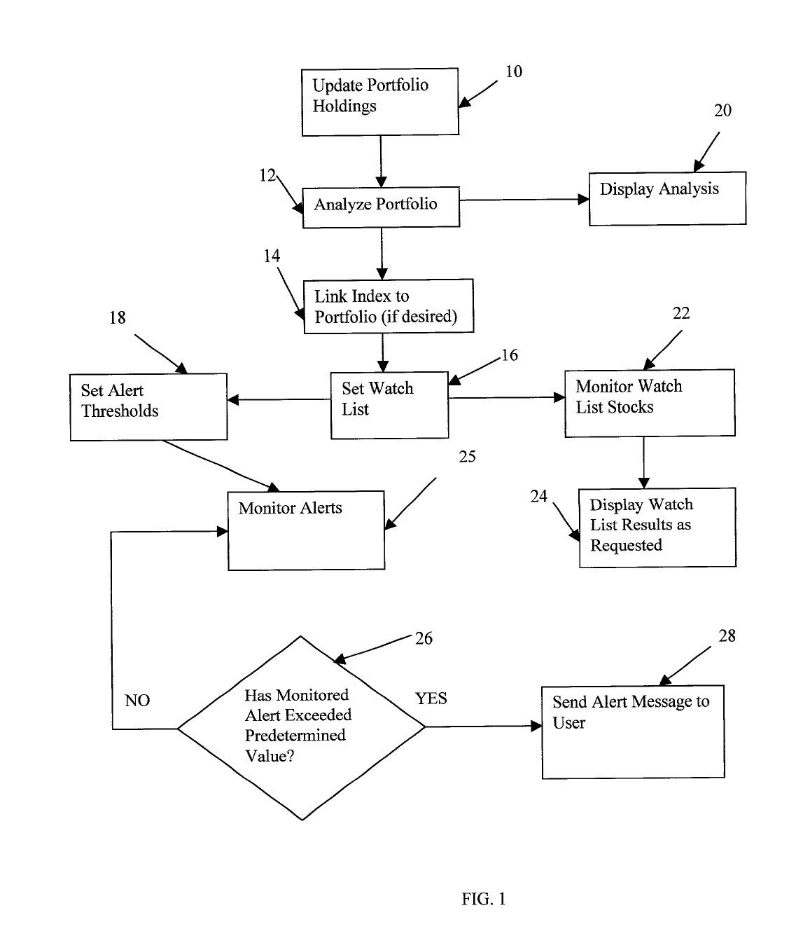

Referring now to FIG. 1, there is shown a method flow chart of one embodiment of the invention showing the steps for managing a portfolio. First, the user uploads, at 10, the portfolio holdings to the central server. The central server analyzes, at 12, the portfolio holdings in accordance with the analysis views described above. The central server then displays, at 20, the analysis as selected by the user. The user also has the option of linking, at 14, the portfolio to an index. By linking an index to a portfolio, the central server will retrieve data about the performance of the portfolio relative to the index.

Next, the user may set, at 16, a Watch List. The Watch List allows the user to monitor, at 22, particular stocks and keep the user posted about the latest developments when requested by the user, at 24. Finally, the user may also set alerts to automatically alert, at 28, the user if a portfolio value (e.g. either an aggregate of stocks or a single stock has decreased in its respective price/earnings ratio) has exceeded, at 26, certain predetermined thresholds.

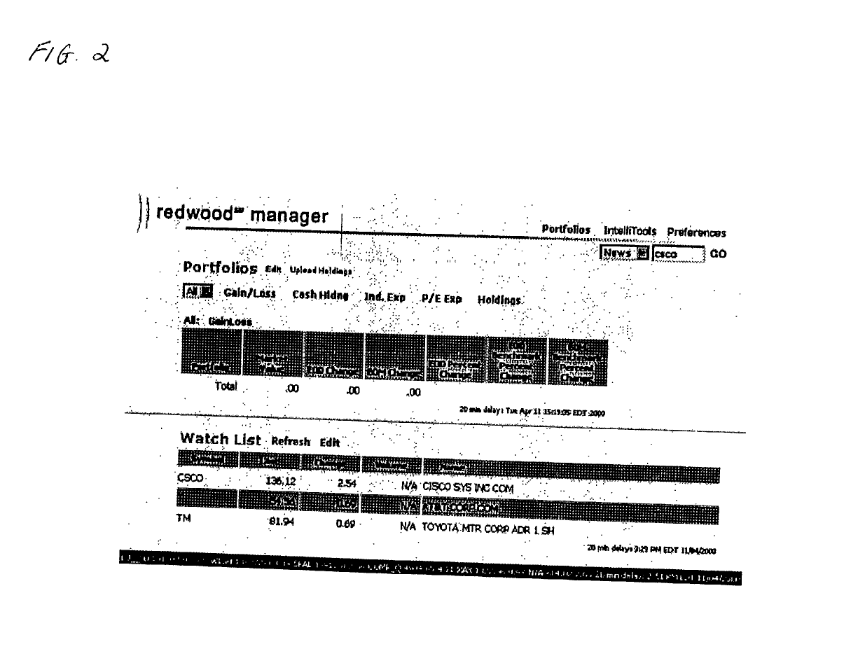

FIG. 2 is the main display screen of the present invention showing a watch list and the results of a gain/loss analysis.

(2) Scanning and Alert

In another aspect, the present invention scans selected Internet message boards and other information sources for messages associated with a given stock or portfolio ticker symbol, and alerts the user if there above-average activity is indicated. Relevant messages are consolidated in an easy-to-read table showing high level data associated with the message. Each message is hyperlinked back to its originating source. In addition, the invention allows the user to filter messages based upon various criteria (e.g., message length, author, data range, etc.), to search for key words, and to calculate summary statistics of message board activity. The invention also allows the user to specify alert thresholds where the user is automatically notified if the number of messages for a particular security exceeds a predetermined number.

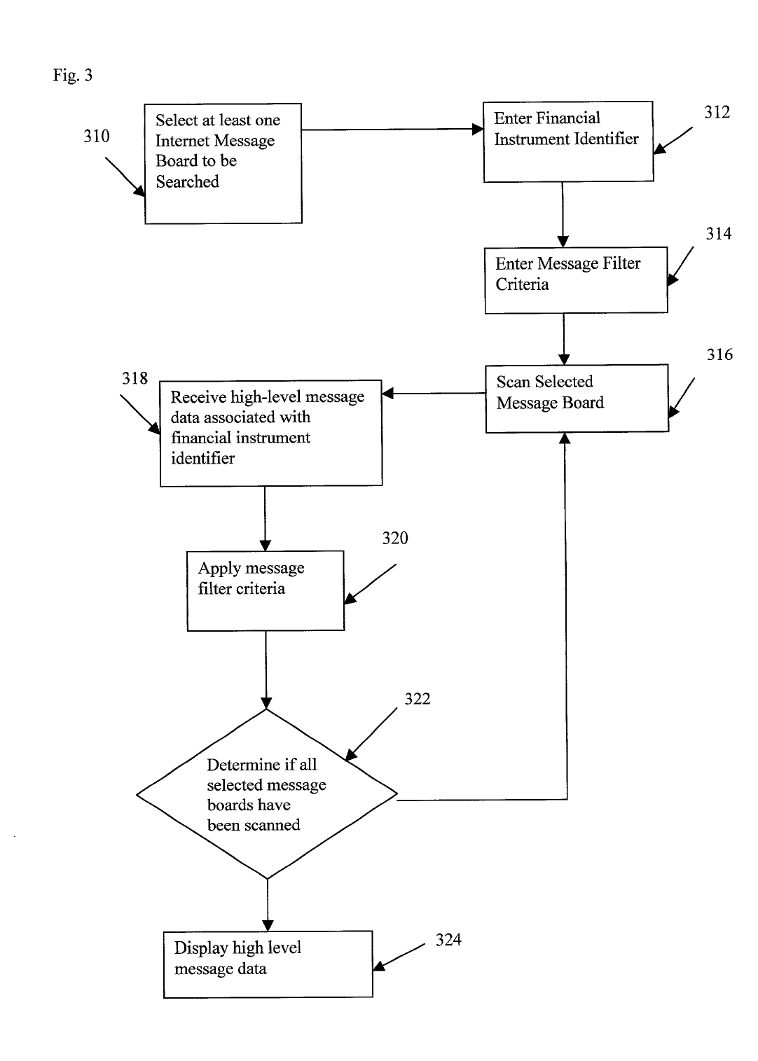

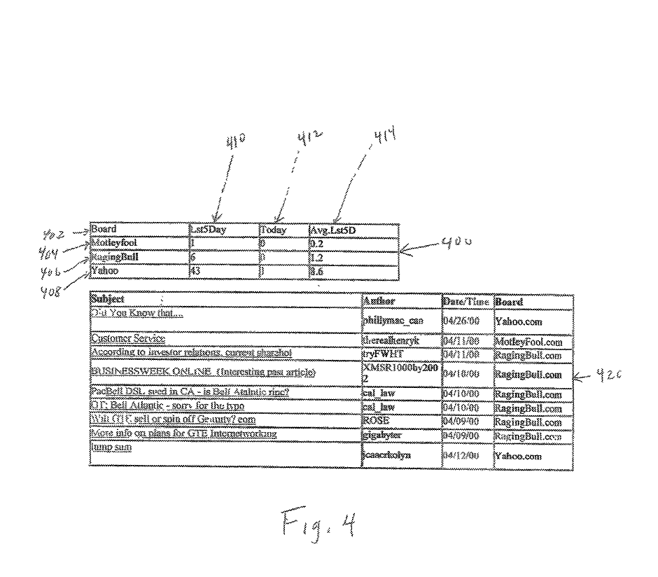

Referring now to FIG. 3, there is shown a method flow chart of one embodiment of this aspect of the invention. The user begins by entering, at 310, at least one Internet message board to be scanned. The user then enters, at 312, an identifier of a financial instrument or security, such as a ticker symbol. Next the user enters, at 314, message filter criteria. The selected Internet message boards are scanned, at 316, and the relevant high-level message data is retrieved at 318. The message filter criteria is applied at 320. A decision point determines at 322 if all the selected message boards have been scanned, and then the filtered message data is displayed to the user at 324 as shown in the screen of FIG. 4. Otherwise, the next Internet message board is scanned, at 316.

FIG. 4 is a sample screen displayed to the user. The screen has a window 400 showing the selected Internet Boards, and a window 420 showing the messages received. The Internet Boards that were selected by the user for searching are shown at 402. In this case, Motleyfool 404, Raging Bull 406 and Yahoo 408 are the Internet boards that have been selected for scanning. The system tracks the number of messages on each board for the last five days, shown in the column titled “Lst5Day” 410, the current day, shown in the column titled “Today”, 412, and the average for the last five days, shown in the column titled “Avg.Lst5D” 414. If the number of messages exceeds a pre-determined threshold number, which could be set as the average number per day, or the average number for the last five days, the system will alert the user. A user can thus monitor unusual activity for selected stocks or financial entities.

(3) Displaying Relationships Among Securities

This aspect of the present invention enables a user to capture his or her knowledge of the relationships between financial securities and to define them in an intuitive, visual manner. The relationships between the financial securities can then be displayed as captured relationships. The captured relationships are displayed with the price change (or other quantity of interest) overlaid with color on top of the relationship diagram. This permits the user to grasp at a glance the dynamics of the relationships, and instantly act on this information. Apart from enabling the user to process information far more quickly, the invention also allows the user to discover relationships and effects of stock price changes that would not be readily apparent using conventional techniques.

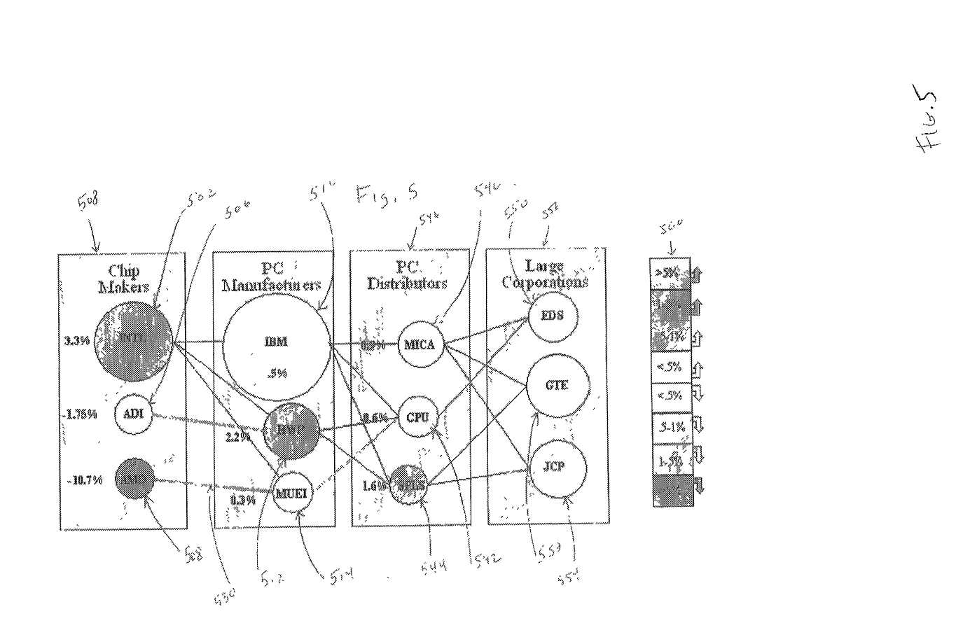

Referring now to FIG. 5, there is shown an entity relationship diagram. The user creates a diagram or graph, using icons such as circles or other shapes, and lines connecting the circles, to represent relationships between entity types. This diagram (and any others the user creates) can be saved and viewed repeatedly. The diagram can also be modified at will.

The user “attaches” specific entities of interest to the circles. The lines drawn between the icons would then signify relationships between these entities. For example, the user can attach a stock ticker identifying specific corporations or companies to each circle. As shown in FIG. 5, the securities “INTL” 502, “ADI” 504 and “AMD” 506 are all chip manufacturers represented by circles enclosed in rectangle titled “Chip Makers” 508. Likewise, “IBM” 510, “HWP” 512 and “MUEI” 514 are PC Manufacturers. A user can represent his knowledge of the relationships between these entities using lines. Thus, lines are drawn between “INTL” and “IBM”, “HWP” and “MUEI” representing business relationships between the entities.

The user can also associate or attach entire markets or industry groups to the circles. The user then links the size of the circle to parameters or variables pertaining to the entity that the circle represents (e.g., market capitalization, revenues, earnings etc. if the circles represent stocks) so that the relative magnitudes of the different entities in the “financial ecosystem” can be grasped at a glance.

Each circle is coded using color-coding or other type of coding such as a fill pattern. The color-coding is defined as a (possibly complex) function of all the attributes that make up the entity. A simple example would be color-coding based on the percentage or absolute change in a relevant numeric quantity pertaining to the attached entity. For example, if the current day's price change for a stock is the chosen numeric quantity, then stocks that are up 5% may be colored green while stocks which are down 5% may be colored red. The colors will change in a dynamic fashion and continuously reflect changes in the underlying numeric variable. The color-coding function is user-definable. In addition, the width and color of the line describing the shape (i.e., circle) may also be variable in order to convey information regarding the entity.

In the present example, as shown at 560, stocks with values up more than 5% are colored deep green, stocks with values up between 1% and 5% are colored light green, values up between 0.5 to 1% are colored deep blue, values up less than 0.5% are colored light blue, values down less than 0.5% are colored light pink, values down between 0.5 and 1% are colored yellow, values down between 1% and 5% are colored orange, and values down more than 5% are colored red. Other color coding schemes may be employed.

As shown in FIG. 5, “INTL” and “HWP” are color-coded light green, showing a stock price increase of between 1% and 0.5%. “ADI” and “CPU” are color-coded yellow, showing a stock price decrease of between 0.5% and 1%. “EDS”, “GTE”, “JCP”, “MICA”, “IBM” and “MUEI” are all color-coded light blue, showing a stock price increase of less than 0.5%. A user can thus track the effect of a change in stock price for one entity to another.

Each line connecting two circles, or financial entities, is color-coded. The color-coding for the line is defined as a (possibly complex) function of the attributes of the two entities that make up the end-point of the line. Thus, the color-coding for the line could be a function of the color-coding of the circles on either end. For example, the user can define a color-coding that says that the line should be colored a “blinking purple” if the circles at either end are color-coded differently. The color of the line will change in a dynamic fashion and continuously reflect changes in the underlying function. The color-coding function will be user-definable. In addition, the width of the line may be adjustable to reflect relative relations between entities. As shown in FIG. 5, a red line 530 is shown connecting “AMD” 508 and “MUEI”, 514 and the line is labeled “0.3%”, signifying the defined relationship between “AMD” and “MUEI”.

The user can “click” on a circle and be immediately presented with detailed data pertaining to that entity. The presented data relates to the function used for the color-coding for that circle and thus points to the “conditions” that lead to that color-coding. For example, when a user clicks on a stock color-coded a “deep green” (thus signifying a price change of over 5% to continue our earlier example), clicking on the circle will present the user with relevant news, press releases, analyst recommendations and the like that may “explain” the increase in the stock price.

In addition, the user can “click” on a line and be immediately presented with detailed data pertaining to that entity. The presented data relates to the function used for the color-coding for that line and thus points to the “conditions” that led to that color-coding. For example, when a user clicks on a line color-coded a “blinking purple” (thus signifying an unequal color-coding of the two end-point circles), clicking on the line will present the user with relevant news, press releases, analyst recommendations etc. for the two end-point stocks juxtaposed side-by-side such that the user can see at a glance why the stock price movements have been dissimilar.

In addition to the foregoing, the user can email any of their intelligent ecosystems to other users.

The user also can set up “alerts” such that when some part of the ecosystem changes in any one of multiple ways, the system will send an alert to the user via email, pager, cell-phone, fax, or any selected method.

Information describing the entities as well as the relationships between them are stored in databases for use in analytic applications.

Users may share parts of their ecosystems with other users in an automatic and transparent fashion. For example, if two entities are part of two distinct ecosystems and if there is a link between them in ecosystem A but not in ecosystem B, the system can alert the user of ecosystem B about the presence of the link in ecosystem A, automatically. Knowledge of the existence of relationships can thereby be effortlessly transferred from one co-worker to another without any investment of time and effort.

(4) Scanning for Similar Securities

The present invention also automatically scans all publicly traded stocks for stocks similar to the given stock or portfolio. The user specifies one or more exemplary or “prototype” securities and similarity criteria, to enable locating a list of similar securities ranked by degree of similarity. Given a user-specified security (such as a stock, bond, fund or the like) as specified by ticker symbols or other standard CUSIP identifiers or the like, the system locates a set of similar securities ranked by degree of similarity, wherein “similarity” is defined by a predefined set of financial attribute criteria. In particular, “similarity” can be defined as a similarity view based on groups of attributes or factors such as market valuation and/or size (e.g., market cap and sales revenues). A similarity view can contain a set of attributes plus relative weights for each of the attributes. In addition, the similarity attributes can also specify Boolean conditions, such as restrictions on the exchange the stock is traded on. Alternatively, a composite security may be specified (such as a portfolio of mixed primitive securities) where the similarity is defined by a set of similarity attributes along with relative weights.

Thus, given a portfolio of securities (a composite security), the system locates candidates for optimizing the composite security based on financial criteria (e.g., simulated gain/loss based on historical data). Given a set of securities, the system will locate a set of similar securities, and a user can thus optimize a portfolio by searching for similar portfolios. For example, if the criteria used to locate a similar security by market cap is the last four weeks gain/loss, then replacing each security in the portfolio with a similar security that has a greater gain in the last four weeks would make the portfolio better. Constructing a universe of partially modified portfolios in this way allows a user to calculate a percentile rank. Using the system, a user could construct 100 similar portfolios, rank the list of portfolios, including the original portfolio, and then rate the original portfolio against the ranked list, by the 4 week gain/loss, to calculate a relative strength kind of calculation. To replace a given security by a similar security, the system calculates the price of the security 4 weeks ago, and then calculate the shares of the new security using the old 4 week price then bring forward any gain/loss.

Still further, the user may specify a fictitious “ideal” security, thereby to locate a set of securities closest to the ideal. The user may define an alert based on the behavior of securities in the “similarity neighborhood” of a simple or composite security simple or composite security. For example, when stocks in the neighborhood of a given stock or portfolio appear in the news or exceed some threshold of performance (whether gain or loss), the alert could be triggered.

In one embodiment of the invention, the similarity function is implemented as a calculation of a “similarity distance” or metric based on the difference between the attributes of a reference security and all other securities. In the preferred embodiment, a weighted Euclidean distance calculation is used to determine the similar securities. According to the preferred embodiment, the system calculates the square of the difference of each of the attributes, and adds the weighted squared values, to calculate the weighted Euclidean distance. In alternate embodiments, neural network clustering and other techniques could be used to measure similarity

Those skilled in the art will appreciate that these methods are within the scope of the invention.

Alternatively, a similarity function can be automatically calculated by first specifying a security, and then a set of securities that is deemed to be similar, and another set that is deemed to be dissimilar. The distance metric can then be used to define clusters, which can define similarity based on an entire group of securities, wherein a new security “belongs” to these clusters. Similarity can also be defined by the known technique of using Self-Organizing Maps (SOMs).

In one example, similarity between financial instruments is determined in the following manner. The user first specifies a ticker symbol or CUSIP identifier for a security. Next, financial attributes for this reference security are located, including a set of attributes and weights, and at least one weighted Euclidean distance between the reference security and all other securities is calculated by squaring the differences between the attributes. The results are then sorted in accordance with a user-defined priority list.

Multiple views can be combined. For example, two views may be used together by combining the attributes and weights of each view. Another way of employing multiple views is to use one view to find similar securities, then another view to reverse sort (i.e., using maximum Euclidean distance) to obtain dissimilarity. Search results also can be filtered by additional criteria, such as risk or compliance measures.

In the case of a composite security, such as a portfolio, the closest securities for each security in the portfolio can be determined as described above. The system finds a similar portfolio by replacing each security in the portfolio by the first, second, third security, and so on, from the nearest match list. The user can thus create “near portfolios” using the similarity search as described above. The system calculates gain/loss by using financial attributes, and calculates additional combinations of these near portfolios and the original portfolio by swapping through random selection and/or using conventional genetic algorithms.

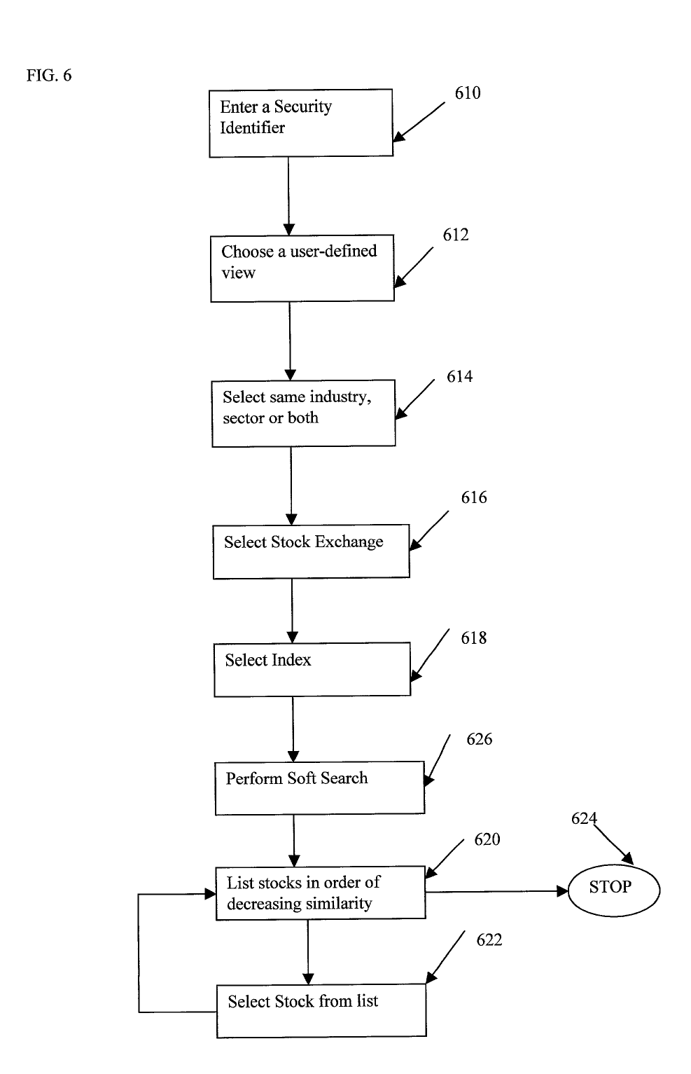

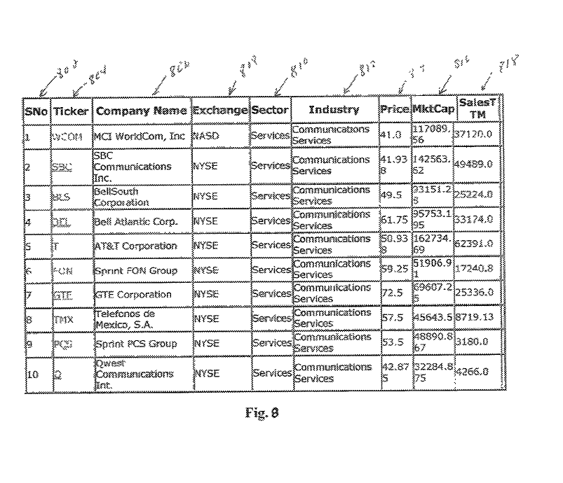

Referring now to FIG. 6, there is shown a method flow chart of one embodiment of the similar searching method according to the invention. The user begins by entering, at 610, a security identifier such as a ticker symbol. Next, the user selects, at 612, a predefined view comprised of previously selected variables. The user may also select, at 614, the same sector or the same industry. Alternatively, the user may leave these sections blank. The user may also elect, at 616, to search for similar stocks traded on particular trading exchanges, if desired. The user then has the option of selecting, at 618, a particular index to further constrain the search boundaries. The system then performs a soft search, at 626, for stocks meeting the similarity factors. The stocks meeting the similarity criteria according to a soft search as described above are listed, at 620, in order of decreasing similarity as shown in FIG. 8. The user may stop, at 624, or select a stock from the list and perform another search with the newly selected stock as the basis for the search.

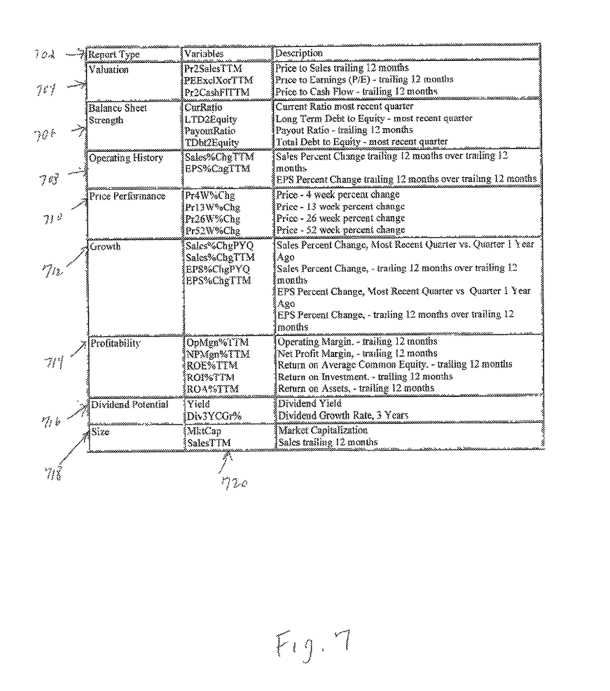

Referring now to FIG. 7, there is shown a sample table of variables from which the user may select to define similarity views. The intelligent similar security search finds stocks related to a given stock ticker and returns a ranked list where the most similar stocks appear at the top of the list. A similarity view can be selected based on various categories, such as valuation, balance sheet strength, operating history, price performance, growth, profitability, dividend potential or size.

The variables shown are grouped according to a report type category as shown in the column titled “Report Type” 702 in FIG. 7. As shown in FIG. 7, the Report Type category can be “Valuation” 704, “Balance Sheet Strength” 706, “Operating History” 708, “Price Performance” 710, “Growth” 712, “Profitability” 714, “Dividend Potential” 716, and “Size” 718. Variables for each of these Report Type categories are shown in “Variable” column 720. For example, similarity based on Price Performance could be defined over the previous four weeks percent change, the previous 13 weeks percent change, the previous 26 weeks percent change, or the previous 52 weeks percent change.

The user may select any or all of the variables shown in the variables column when defining what variables are used in searching for similar stocks according to the soft search methods described above.

Referring to FIG. 8, an example of a display for a stock similarity search result is shown. The present invention can list the stocks by the degree of similarity as shown in the column titled “Similarity Number” 802. The display also has columns for “Ticker” 804, “Company Name” 806, “Exchange” 808, “Sector” 810, “Industry” 812, “Price” 814, “MktCap” 816, and “Sales TTM” 818.

Additional information regarding particular embodiments of the invention is set forth in the attached Appendix A, entitled “Redwood Manager for Palm User Manual”, and Appendix B, “High Level Technology Architecture”, “Redwood Manager” and “The Redwood Network”.

It should be understood that various alternatives and modifications can be devised by those skilled in the art without departing from the invention. Accordingly, the present invention is intended to embrace all such alternatives, modifications and variances that fall within the scope of the appended claims.

What is claimed is:

1. A computer-implemented system for supporting financial decisions by alerting a user when the number of references to a selected financial instrument on at least one selected internet site exceeds a pre-determined amount, the system comprising:
means for searching the selected internet site for references to the selected financial instrument;
means for counting a time-defined number of references to the selected financial instrument on the selected internet site over a first period of time;
means for setting a threshold number of references; and
means for sending an alert to the user of the system when the time-defined number of references to the selected stock in the first period of time exceeds the threshold number of references.

2. The system of claim 1 wherein the threshold number of references is an average reference number, and the means for setting a threshold number of references further comprises means for determining the average number of references in a second period of time.

3. The system of claim 2 wherein the means for determining the average number of references further comprises:
means for storing information representative of the number of references to the selected financial instrument over the second period of time;
means for determining the average number of references over the second period of time; and
means for comparing the counted number of references to the selected financial instrument on the selected internet sites over the first period of time with the average number of references.

4. A computer-implemented method for supporting financial decisions by alerting a user when the number of references to a selected financial instrument on at least one selected internet site exceeds a pre-determined amount, the method comprising:
searching the selected internet site for references to the selected financial instrument;
counting a time-defined number of references to the selected financial instrument on the selected internet site over a first period of time;
setting a threshold number of references; and
sending an alert to the user when the time-defined number of references to the selected stock in the first period of time exceeds the threshold number of references.

5. The method of claim 4 wherein the threshold number of references is an average reference number, and setting a threshold number of references further comprises determining the average number of references in a second period of time.

6. The system of claim 5 wherein determining the average number of references further comprises:
storing information representative of the number of references to the selected financial instrument over the second period of time;
determining the average number of references over the second period of time; and
comparing the counted number of references to the selected financial instrument on the selected internet sites over the first period of time with the average number of references.

7. A computer-implemented system for supporting financial decisions by searching for similar securities, the system comprising:
means for receiving a user-specified security from a user;
means for determining a similarity criteria comprised of at least two security attributes, each with an associated relative weight;
means for searching a set of securities wherein each security in the set has associated similarity attributes, each security attribute having a value;
means for determining a group of similar securities from the set of securities by weighting the difference between the value of each attribute of each security in the set and the value of the corresponding attribute of the user-specified security using the associated relative weight; and
means for displaying the group of similar securities.

8. The system of claim 7 wherein the security attribute is one of market valuation, balance sheet strength, operating history, price performance, growth, profitability, dividend potential, or entity size.

9. A computer-implemented system for supporting financial decisions by searching for similar securities, the system comprising:
means for receiving a user-specified security from a user;
means for determining a similarity criteria comprised of at least two security attributes;
means for searching a set of securities wherein each security in the set has associated similarity attributes, each security attribute having a value;
means for determining a group of similar securities from the set of securities by comparing the difference between the value of each attribute of each security in the set and the value of the corresponding attribute of the user-specified security; and
means for displaying the group of similar securities.

10. The system of claim 9 wherein each security attribute has an associated relative weight, and the means for determining the group of similar securities further comprises means for weighting the difference between the values of the attributes using the associated relative weight.

11. The system of claim 9 wherein the difference between the value of the attribute of each security in the set and the value of the corresponding attribute of the user-specified security is a metric.

12. The system of claim 11 wherein the metric further comprises a similarity distance.

13. The system of claim 12 wherein the metric further comprises a weighted Euclidean distance.

14. The system of claim 13 wherein the similar securities are sorted by a user-defined priority list.

15. A computer-implemented method for supporting financial decisions by searching for similar securities, the method comprising:
receiving a user-specified security from a user;
determining a similarity criteria comprised of at least two security attributes, each with an associated relative weight;
searching a set of securities wherein each security in the set has associated similarity attributes, each security attribute having a value;
determining a group of similar securities from the set of securities by weighting the difference between the value of each attribute of each security in the set and the value of the corresponding attribute of the user-specified security using the associated relative weight; and
displaying the group of similar securities.

16. The method of claim 15 wherein the security attribute is one of market valuation, balance sheet strength, operating history, price performance, growth, profitability, dividend potential, or entity size.

17. A computer-implemented method for supporting financial decisions by searching for similar securities, the method comprising:
receiving a user-specified security from a user;
determining a similarity criteria comprised of at least two security attributes;
searching a set of securities wherein each security in the set has associated similarity attributes, each security attribute having a value;
determining a group of similar securities from the set of securities by comparing the difference between the value of each attribute of each security in the set and the value of the corresponding attribute of the user-specified security; and
displaying the group of similar securities.

18. The method of claim 17 wherein each security attribute has an associated relative weight, and determining the group of similar securities further comprises weighting the difference between the values of the attributes using the associated relative weight.

19. The method of claim 18 wherein the difference between the value each attribute of each security in the set and the value of the corresponding attribute of the user-specified security is a metric.

20. The method of claim 19 wherein the metric further comprises a similarity distance.

21. The method of claim 19 wherein the metric further comprises a weighted Euclidean distance.

22. The method of claim 21 wherein the similar securities are sorted by a user-defined priority list.

23. A computer-implemented system for supporting financial decisions by searching for a similar portfolio, the system comprising:
means for receiving a user-specified portfolio comprised of a plurality of securities from a user;
means for receiving a similarity criteria comprised of at least one security attribute and an associated relative weight from a user;
means for searching a set of securities, each security having associated security attributes;
means for determining a similar security, from the set of securities, for each security in the user-specified portfolio by comparing the security attribute of each security in the user-specified portfolio to the security attribute of each security in the set of securities;
means for creating a similar portfolio comprised of the similar securities; and
means for displaying the similar portfolio.

24. The system of claim 23 wherein the difference between the value of each attribute of each security in the user-specified portfolio and the value of the corresponding attribute of the security in the set of securities is a similarity distance metric.

25. A computer-implemented method for supporting financial decisions by searching for a similar portfolio, the method comprising:
receiving a user-specified portfolio comprised of a plurality of securities from a user;
receiving a similarity criteria comprised of at least one security attribute and an associated relative weight from a user;
searching a set of securities, each security having associated security attributes;
determining a similar security, from the set of securities, for each security in the user-specified portfolio by comparing the security attribute of each security in the user-specified portfolio to the security attribute of each security in the set of securities;
creating a similar portfolio comprised of the similar securities; and
displaying the similar portfolio.

26. The method of claim 25 wherein the difference between the value of each attribute of each security in the user-specified portfolio and the value of the corresponding attribute of the security in the set of securities is a similarity distance metric.

27. A computer-implemented system for supporting financial decisions by searching for dissimilar securities, the system comprising:
means for receiving a user-specified security from a user;
means for determining a similarity criteria comprised of at least one security attribute;
means for determining a dissimilarity criteria;
means for determining a set of similar securities from a set of securities by comparing the security attribute of the user-specified security with the security attribute of the securities in the set of securities;
means for determining which of the similar securities meet the dissimilarity criteria when compared to the user-specified security; and
means for displaying the dissimilar securities.

28. The system of claim 27 wherein the means for determining the set of similar securities is further comprised of means for calculating a metric representing the difference between each attribute of the user-specified security and each attribute of each security in the set of securities.

29. A computer-implemented method for supporting financial decisions by searching for dissimilar securities, the method comprising:
receiving a user-specified security from a user;
determining a similarity criteria comprised of at least one security attribute;
determining a dissimilarity criteria;
determining a set of similar securities from a set of securities by comparing the security attribute of the user-specified security with the security attribute of the securities in the set of securities;
determining which of the similar securities meet the dissimilarity criteria when compared to the user-specified security; and
displaying the dissimilar securities.

30. The method of claim 29 wherein determining the set of similar securities is further comprised of calculating a metric representing the difference between each attribute of the user-specified security and each attribute of each security in the set of securities.

31. A computer-implemented system for supporting financial decisions by searching for securities having user-specified attributes, the system comprising:
means for receiving a user-specified similarity criteria comprised of at least two security attributes, each with an associated relative weight;
means for searching a set of securities wherein each security in the set has associated similarity attributes, each security attribute having a value;
means for determining a group of similar securities from the set of securities by weighting the difference between the value of each attribute of each security in the set and the value of the corresponding user-specified security attributes; and
means for displaying the securities having the user-specified attributes.

32. The system of claim 31 wherein the difference between the value of each attribute of each security in the set and the value of the corresponding user-specified security attributes is further comprised of a metric between the user-specified security and each of the similar securities.

33. A computer-implemented method for supporting financial decisions by searching for securities having user-specified attributes, the method comprising:
receiving a user-specified similarity criteria comprised of at least two security attributes, each with an associated relative weight;
searching a set of securities wherein each security in the set has associated similarity attributes, each security attribute having a value;
determining a group of similar securities from the set of securities by weighting the difference between the value of each attribute of each security in the set and the value of the corresponding user-specified security attributes; and
displaying the securities having the user-specified attributes.

34. The method of claim 33 wherein the difference between the value of each attribute of each security in the set and the value of the corresponding user-specified security attributes is further comprised of a metric between the user-specified security and each of the similar securities.

35. A computer-implemented interactive display system for supporting financial decisions by allowing a user to visually display financial entities and a dynamic relationship between the financial entities on a graphical user interface, the system comprising:
a graphical user interface (GUI) disposed on the display system,
means for displaying a first icon representative of a first financial entity, wherein a characteristic of the first icon represents a quantity of interest of the first financial entity;
means for displaying a second icon representative of a second financial entity, wherein a characteristic of the second icon represents a quantity of interest of the second financial entity;
means for displaying a symbol representative of a user-defined dynamic relationship between the first financial entity and the second financial entity wherein a characteristic of the symbol represents a quantity of interest of the relationship;
means for detecting a change in the quantity of interest of the first financial interest;
means for changing the characteristic of the first icon in response to detecting a change in the quantity of interest of the first financial entity;
means for detecting a change in the quantity of interest of the second financial entity; and
means for changing the characteristic of the second icon in response to detecting a change in the quantity of interest of the second financial entity.

36. The system of claim 35 wherein the characteristic of the icon is a color-code.

37. The system of claim 36 wherein the quantity of interest is a change in value of the financial entity over a pre-determined time period.

38. The system of claim 37 wherein the size of the first icon represents a parameter of the financial entity.

39. The system of claim 38 wherein the parameter is one of market capitalization, revenues or earnings of the financial entity.

40. The system of claim 39 wherein the financial entity is a stock value of a company.

41. The system of claim 39 wherein the financial entity is a stock value of a group of companies.

42. The system of claim 38 wherein an icon includes a geometric shape.

43. The system of claim 42 wherein the geometric shape includes circle, triangle or square.

44. The system of 43 wherein the geometric shape has different fill pattern including solid or hollow.

45. The system of 44 wherein the symbol representative of the user-defined relationship is a line.

46. The system of claim 45 wherein the line is color-coded.

47. The system of claim 46 wherein the color-code of the line is defined as a function of the attributes of the relationship between the first financial entity and the second financial entity.

48. The system of claim 47 wherein the line comprises a width that is variable and the line width is defined as a function of the relative relationship between the first financial entity and the second financial entity.

49. A computer-implemented interactive display method for supporting financial decisions by allowing a user to visually display financial entities and a dynamic relationship between the financial entities on a graphical user interface, the method comprising:
displaying, to the user, a first icon representative of a first financial entity, wherein a characteristic of the first icon represents a quantity of interest of the first financial entity;
displaying, to the user, a second icon representative of a second financial entity, wherein a characteristic of the second icon represents a quantity of interest of the second financial entity;
displaying, to the user, a symbol representative of a user-defined dynamic relationship between the first financial entity and the second financial entity wherein a characteristic of the symbol represents a quantity of interest of the relationship;
detecting a change in the quantity of interest of the first financial interest;
changing the characteristic of the first icon in response to detecting a change in the quantity of interest of the first financial entity;
detecting a change in the quantity of interest of the second financial entity; and
changing the characteristic of the second icon in response to detecting a change in the quantity of interest of the second financial entity.

50. The method of claim 49 wherein the characteristic of the icon is a color-code.

51. The method of claim 50 wherein the quantity of interest is a change in value of the financial entity over a pre-determined time period.

52. The method of claim 51 wherein the size of the first icon represents a parameter of the financial entity.

53. The method of claim 52 wherein the parameter is one of market capitalization, revenues or earnings of the financial entity.

54. The method of claim 53 wherein the financial entity is a stock value of a company.

55. The method of claim 53 wherein the financial entity is a stock value of a group of companies.

56. The method of claim 53 wherein an icon includes a geometric shape.

57. The method of claim 56 wherein the geometric shape includes circle, triangle or square.

58. The method of 59 wherein the geometric shape has different fill pattern including solid or hollow.

59. The method of 58 wherein the symbol representative of the user-defined relationship is a line.

60. The method of claim 59 wherein the line is color-coded.

61. The method of claim 60 wherein the color-code of the line is defined as a function of the attributes of the relationship between the first financial entity and the second financial entity.

62. The method of claim 61 wherein the line comprises a width that is variable and the line width is defined as a function of the relative relationship between the first financial entity and the second financial entity.
